(19) United States
(12) Patent Application Publication
(10) Pub. No.: US 2026/0211154 A1
(43) Pub. Date: Jul. 23, 2026

(54) SYSTEM AND METHOD FOR METEOROLOGICAL MODELLING

(71) Applicant: Skyfora Oy, Helsinki (FI)

(72) Inventors: Svante HENRIKSSON, Helsinki (FI); Fredrik BORGSTRÖM, Helsinki (FI); Kim KAISTI, Helsinki (FI)

(21) Appl. No.: 18/878,121

(22) PCT Filed: Jun. 30, 2023
(86) PCT No.: PCT/FI2023/050409

§ 371 Date: Dec. 23, 2024

(30) Foreign Application Priority Data
Jul. 1, 2022 (FI) 20225616

(51) Int. Cl. G01W 1/10; G01S 19/14; G01W 1/08

(52) U.S. Cl. CPC G01W 1/10; G01S 19/14; G01W 1/08

(57) ABSTRACT

A system and method for meteorological modelling. The method includes carrying out data exchange in an infrastructure network, receiving navigation satellite system signals from the navigation satellites of the global navigation satellite system in the infrastructure network nodes, and controlling operation of the infrastructure network nodes based on the received navigation satellite system signals. The method further includes determine atmospheric delays of the navigation satellite system signals, and calculating atmospheric quantities between the navigation satellites and the infrastructure network nodes based on the determined atmospheric delays of the navigation satellite system signals.

### FIELD OF THE INVENTION

The present invention relates to a system for meteorological modelling and more particularly to a system according to preamble of claim 1. The present invention relates to a method for meteorological modelling and more particularly to a method according to preamble of claim 22.

### BACKGROUND OF THE INVENTION

Global navigation satellite system (GNSS) meteorology is a concept, whereby GNSS signal delays between navigation satellites and GNSS receivers are calculated and used to derive atmospheric quantities. Water vapor causes the largest variations to such signal delays in a typical case. Also, temperature and pressure variations contribute to variations in GNSS signal delay. GNSS meteorology is called GPS meteorology in case the GPS satellite navigation system is applied.

In prior art, meteorological calculations of atmospheric quantities, such as atmospheric refractivity, humidity, temperature or pressure, based on navigation satellite system signals from navigation satellites are typically carried out at GPS/GNSS ground stations or dedicated meteorological base stations or other global navigation satellite system (GNSS) reference networks of very limited scope. These GNSS receiver networks are configured to receive navigation satellite system signal raw data. As GNSS receivers are becoming more and more affordable and ubiquitous, a lot of potential navigation satellite system raw signal data is currently heavily under-utilized and typically not even stored. In a typical case, navigation output messages comprising time and location data are stored and used, while satellite system raw data comprising more detailed information about the GNSS signals is only used as intermediate data in GNSS receivers for more processed navigation output messages and immediately discarded thereafter. By storing and utilizing detailed signal data from amongst the raw data, global navigation satellite systems can be used for meteorology beyond its primary purposes of positioning and timing. Code and carrier phase measurements of signals from specific navigation satellites can be used in conjunction with external correction data to evaluate details of atmospheric refractivity and meteorological parameters such as water vapor, temperature and pressure.

One of the problems associated with the prior art is that the weather forecasting, commonly done using numerical weather prediction models, needs a great amount of meteorological data from a large number of local meteorological sensors and atmospheric weather sondes in addition to navigation satellite system signals for generating a meteorological forecast of sufficient skill. The meteorological data derived from current GNSS meteorology are insufficient for determining three-dimensional meteorological models and forecasts as well as local forecasts due to limited geographical coverage efficiently and accurately. In other words, GNSS meteorology remains one input amongst many other measurement data and its benefits are currently limited for this reason.

### BRIEF DESCRIPTION OF THE INVENTION

An object of the present invention is to provide a system and method for meteorological modelling so as to solve or at least alleviate the prior art disadvantages.

The objects of the invention are achieved by a system for meteorological modelling which is characterized by what is stated in the independent claim 1. The objects of the invention are further achieved by a method for meteorological modelling which is characterized by what is stated in the independent claim 22.

The preferred embodiments of the invention are disclosed in the dependent claims.

The invention is based on the idea of providing system for meteorological modelling, the system comprising global navigation satellite system comprising:
a space segment having navigation satellites,
a control segment having ground-based satellite stations, and
a client segment having plurality of navigation satellite signal receiving client nodes.

The client segment comprises an infrastructure network comprising plurality of separate infrastructure network nodes provided over a geographical area. The infrastructure network nodes comprise:
an infrastructure network communication module configured to carry out data exchange in the infrastructure network,
a navigation satellite system module having a navigation satellite system receiver configured to receive navigation satellite system signals from the navigation satellites of the global navigation satellite system, and
an infrastructure network control module configured to control data exchange via the infrastructure network communication module and to control operation of the infrastructure network node based on the received navigation satellite system signals.

The system further comprises a meteorological modelling module configured to:
determine atmospheric delay of the navigation satellite signal between the navigation satellite and the infrastructure network node, and
calculate atmospheric quantity in a direction between the navigation satellite and the infrastructure network node based on the determined atmospheric delay of the navigation satellite signal between the navigation satellite and the infrastructure network node.

In the present application term atmospheric delay comprises an ionospheric delay, a tropospheric delay or the ionospheric delay and the tropospheric delay.

In the context of this application the tropospheric delay comprises both the tropospheric delay and the lower stratospheric delay due to dry gases and water vapor and clouds.

The lower stratospheric delay is much smaller than the tropospheric delay.

It should be noted that the present invention is not directed to calculation of the atmospheric delay, tropospheric delay, ionospheric delay and/or the stratospheric delay itself. The delay calculations are generally known.

The present invention enables providing three-dimensional local weather forecasts and measurements by utilizing navigation satellite systems and infrastructure networks.

In some embodiments, the system comprises two or more different navigation satellite systems, and the navigation satellite system module comprises a multi-system navigation satellite system receiver configured to receive navigation satellite system signals from the navigation satellites of two or more navigation satellite systems.

In some other embodiments, the system comprises two or more different navigation satellite systems, and the navigation satellite system module comprises a first navigation satellite system receiver configured to receive navigation satellite system signals from the navigation satellites of a first navigation satellite system, and a second navigation satellite system receiver configured to receive configured to receive navigation satellite system signals from the navigation satellites of a second navigation satellite system.

Utilizing two or more different navigation satellite systems enables better coverage.

In some embodiments, the infrastructure network is a fixed infrastructure network comprising fixed infrastructure network nodes at fixed geographical locations.

The fixed infrastructure network enables exact local forecasts.

In some embodiments, the infrastructure network is a fixed telecommunication network comprising telecommunication network base stations as the infrastructure network nodes at fixed geographical locations.

In some other embodiments, the infrastructure network is a mobile telecommunication network comprising mobile telecommunication network base stations as the infrastructure network nodes at fixed geographical locations.

In some further embodiments, the infrastructure network is a 3G, 4G, 5G, 6G or 7G telecommunication network comprising telecommunication network base stations as the infrastructure network nodes at fixed geographical locations.

Telecommunication networks provide wide area coverage as well as dense network with great number of infrastructure nodes or base stations.

In some embodiments, the infrastructure network is an energy infrastructure network comprising energy control base stations as the infrastructure network nodes at fixed geographical locations, or a road or railroad infrastructure network comprising road control base stations as the infrastructure network nodes at fixed geographical locations, or a lighting infrastructure network comprising lighting control base stations as the infrastructure network nodes at fixed geographical locations.

In some embodiments, the infrastructure network is a mobile client infrastructure network comprising mobile infrastructure network nodes, or a vehicle infrastructure network comprising vehicles infrastructure network nodes. Mobile client infrastructure network provides variable coverage also in graphical areas having no fixed infrastructure networks.

In some embodiments, the infrastructure network is a multi-client infrastructure network comprising fixed infrastructure network nodes at fixed geographical locations, and mobile infrastructure network nodes.

Multi-client infrastructure network enables utilizing both fixed and mobile infrastructure nodes.

In some embodiments, the navigation satellite system receiver is single frequency navigation satellite system receiver configured to receive navigation satellite system signals from navigation satellites on one frequency.

In some other embodiments, the navigation satellite system receiver is a dual-frequency navigation satellite system receiver configured to receive navigation satellite system signals having a first frequency and navigation satellite system signals having a second frequency.

In some further embodiments, the navigation satellite system receiver is a multi-frequency navigation satellite system receiver configured to receive navigation satellite system signals on multiple different frequencies.

In some yet further embodiments, the navigation satellite system module comprises a first frequency navigation satellite system receiver configured to receive navigation satellite system signals having a first frequency, and a second frequency navigation satellite system receiver configured to receive navigation satellite system signals having a second frequency.

Utilizing two or more frequencies enables theoretical calculation of ionospheric delay which is dependent on signal frequency.

The ionospheric delay is closely coupled with the electron count of the space plasma in the ionosphere. By determining the electron count through processing of the ionospheric delay, the ionospheric delay may be used to monitor space weather.

In some embodiments, the meteorological modelling module is configured to determine the atmospheric delay of the navigation satellite signal between the navigation satellite and the infrastructure network node based on the navigation satellite signal having the first frequency and the navigation satellite system signal having the second frequency.

In some other embodiments, the meteorological modelling module is configured to determine atmospheric delay of the navigation satellite signal between the navigation satellite and the infrastructure network node based on the navigation satellite system signals having different frequencies.

In some embodiments, the infrastructure network control module configured to control timing, or synchronization, or timing and synchronization of the infrastructure network node in the infrastructure network is based on the received navigation satellite system signals.

In some other embodiments, the navigation satellite system receiver is configured to generate navigation output messages, and the infrastructure network control module is configured to control timing, or synchronization, or timing and synchronization of the infrastructure network node in the infrastructure network based on the generated navigation output messages generated by the navigation satellite system receiver.

Accordingly, the infrastructure network utilized time and location information provided by the navigation satellite system signals.

In some embodiments, the navigation satellite system receiver is configured to generate signal characteristic output messages, and the meteorological modelling module is configured to calculate the atmospheric delay based on the signal characteristics output messages generated by the navigation satellite system receiver.

Accordingly, the meteorological modelling module is configured to utilize signal characteristics, or raw data, of the navigation satellite system signals.

Accordingly, the infrastructure network and the meteorological modelling module utilize different elements of the navigation satellite system signals or different output messages or output data of the navigation satellite system receiver.

In some embodiments, the meteorological modelling module is provided to the infrastructure network node.

In some other embodiments, the system comprises an external meteorological modelling server arranged in data exchange connection with the infrastructure network nodes of the infrastructure network, the meteorological modelling module is provided to the external meteorological modelling server.

In some further embodiments, the system is provided as distributed system in which the meteorological modelling module and operation thereof is distributed between the infrastructure network nodes and an external meteorological modelling server arranged in data exchange connection with the infrastructure network nodes of the infrastructure network.

In some further embodiments, the meteorological modelling module is distributed between the infrastructure network nodes in such a way, that the GNSS signal delays of interest are calculated in the infrastructure network nodes and the atmospheric quantity or atmospheric quantities are derived or calculated in the external meteorological modelling module.

The ionosphere is a dispersive medium for electromagnetic radiation at the relevant frequencies. Different GNSS signal frequencies experience different signal delays according to a well-known frequency-dependent formula. Hence, if the GNSS receivers that form part of the navigation satellite system module are receiving GNSS signals at two or more frequencies, the ionospheric delay can be removed in calculations. This allows calculating GNSS signal delays for the troposphere. These delays are called tropospheric delays. Zenith Tropospheric Delay is the delay that a GNSS signal experiences from a navigation satellite that is in zenith above the GNSS receiver. Slant delays, on the other hand, refer to GNSS signal delays, where the signal path between a navigation satellite and a GNSS receiver is slant.

GNSS tomography or global navigation satellite system tomography refers to a method, where multiple slant delays are used in an algorithm to derive a three-dimensional field of an atmospheric quantity or several atmospheric quantities. Typically, such an algorithm applies mathematical inversion. The region of the atmosphere of interest (whether geographically limited or global) can for example be divided into a grid and when enough slant delays are known, the atmospheric refractivity for each grid point can be derived through a mathematical inversion method. Such methods typically employ some form of optimization. As water vapor causes the largest variations over time to the GNSS signal delay, a common method is to use meteorological surface data from measurements or modelling and assuming a standard atmosphere in terms of pressure and humidity and then using the refractivity field obtained from GNSS tomography to derive the water vapor field. This so called Tropospheric Wet Delay may also contain components from liquid and/or solid water (ice). In case of looking at the contribution of water vapor to a zenith signal delay, it is called Zenith Wet Delay. Liquid water and ice may also be solved in an algorithm by using e.g. radar, satellite or radiosonde data in conjunction with a GNSS tomography algorithm. Three-dimensional temperature and pressure distributions can also be derived if one applies some further measurement data and/or assumptions, and wind can be derived by tracking the movement of features in time seen in the derived atmospheric refractivity, water vapor, temperature and pressure fields.

In a typical application, the Zenith Tropospheric Delay is derived from multiple slant delays through a dedicated algorithm. This is due to the fact that there is typically no navigation satellite right above the GNSS receiver in zenith. Hence multiple slant delays need to be used to calculate the Zenith Tropospheric Delay, which is the delay that is calculated for a hypothetical satellite in zenith above the GNSS receiver at a given point in time.

In some embodiments, the meteorological modelling module is configured to determine Tropospheric Delay of the navigation satellite signal between the navigation satellite and the infrastructure network node based on the navigation satellite signal received in the navigation satellite system module.

In some other embodiments, the meteorological modelling module is configured to determine Tropospheric Delay of the navigation satellite system signals between two or more navigation satellites and the infrastructure network node based on the navigation satellite system signals received in the navigation satellite system module.

In some further embodiments, the meteorological modelling module is configured to determine Tropospheric Delay of the navigation satellite signal between the navigation satellite and the infrastructure network node on the navigation satellite signal received in the navigation satellite system module, and further Wet Delay of the navigation satellite signal between the navigation satellite and the infrastructure network node based on the determined Tropospheric Delay.

In some yet further embodiments, the meteorological modelling module is configured to determine Tropospheric Delay of the navigation satellite system signals between two or more navigation satellites and the infrastructure network node based on the navigation satellite system signals received in the navigation satellite system module, and further Wet Delay of the navigation satellite system signals between the two or more navigation satellites and the infrastructure network node based on the determined Tropospheric Delay.

In some embodiments, the meteorological modelling module is configured to determine signal delay of the navigation satellite signal between the navigation satellite and the infrastructure network node with Radio Occultation based on the navigation satellite signal received in the navigation satellite system module during movement of the navigation satellite relative to one or more infrastructure network nodes. Radio Occultation may be utilized for example with mobile infrastructure nodes at high altitude, such as airplanes. Radio Occultation may also be utilized for example with fixed infrastructure nodes provided at high altitudes with good horizontal visibility, such as mountain areas, high constructions or coastal areas. In some embodiments the meteorological modelling module is configured to carry out global navigation satellite system tomography between two or more navigation satellites and one or more infrastructure network nodes based on the navigation satellite system signals received in the one or more infrastructure network nodes.

In some alternative embodiments, the meteorological modelling module is configured to carry out global navigation satellite system tomography between two or more navigation satellites and the infrastructure network node based on the navigation satellite system signals received in the one or more infrastructure network nodes.

In some embodiments, the global navigation satellite system tomography comprises determining atmospheric delays between two or more navigation satellites and one or more infrastructure network nodes, and calculating one or more atmospheric quantities between two or more navigation satellites and one or more infrastructure network nodes based on the determined atmospheric delays.

In some other embodiments, the global navigation satellite system tomography comprises determining atmospheric delays between two or more navigation satellites and the infrastructure network node, and calculating one or more atmospheric quantities between two or more navigation satellites and the infrastructure network node based on the determined atmospheric delays.

In some embodiments, the meteorological modelling module is configured to determine a three-dimensional distribution of the one or more atmospheric quantities in the atmosphere based on the navigation satellite system signals received in the navigation satellite system modules of the one or more infrastructure network nodes from two or more navigation satellites by global navigation satellite system tomography.

In some other embodiments, the meteorological modelling module is configured to determine a three-dimensional distribution of the one or more atmospheric quantities in the atmosphere based on the navigation satellite system signals received in the navigation satellite system module of the infrastructure network node from two or more navigation satellites by global navigation satellite system tomography.

In some embodiments, the infrastructure network is the fixed telecommunication network comprising telecommunication network base stations as the infrastructure network nodes at fixed geographical locations, and the meteorological modelling module is configured to determine the three-dimensional distribution of the one or more atmospheric quantities in the atmosphere based on the navigation satellite system signals received in the navigation satellite system modules of the fixed infrastructure network nodes from two or more navigation satellites by global navigation satellite system tomography.

In some embodiments, the meteorological modelling module is configured to determine three-dimensional water vapor distribution in the atmosphere based on the navigation satellite system signals received in the navigation satellite system module from two or more navigation satellites by global navigation satellite system tomography.

In some embodiments, the meteorological modelling module is configured to determine a three-dimensional atmospheric refractivity distribution in the atmosphere based on the determined slant delays of the navigation satellite system signals between the two or more navigation satellites and the infrastructure network node by global navigation satellite system tomography.

In some embodiments, the system comprises one or more atmospheric sensors arranged in communication connection with the meteorological modelling module. The meteorological modelling module is configured to receive atmospheric measurement data from the one or more atmospheric sensors. The meteorological modelling module is further configured to determine the three-dimensional distribution of the one or more atmospheric quantities in the atmosphere based on the navigation satellite system signals and the atmospheric measurement data from the one or more atmospheric sensors.

In some further embodiments, the meteorological modelling module is configured to determine a three-dimensional distribution of one or more of the following atmospheric quantities: atmospheric refractivity, water vapor, liquid water, ice, temperature, pressure and wind, based on the determined slant delays of the navigation satellite system signals between the two or more navigation satellites and the infrastructure network node by global navigation satellite system tomography.

In some embodiments, the meteorological modelling module is configured to determine the meteorological modelling module is configured to determine three-dimensional water vapor distribution in the atmosphere based on the determined Tropospheric Delay or Wet Delay of the navigation satellite system signals between the two or more navigation satellites and the infrastructure network node by global navigation satellite system tomography.

In some embodiments, the atmospheric quantity is one or more of the following: water vapor, liquid water, atmospheric refractivity, ice, temperature, pressure, humidity and wind.

In some embodiments, the meteorological modelling module is configured to determine the atmospheric delays of the navigation satellite system signals between the navigation satellite and two or more infrastructure network nodes, and calculate the atmospheric quantity between the navigation satellite and the two or more infrastructure network nodes based on the determined atmospheric delays of the navigation satellite system signals between the navigation satellite and the two or more infrastructure network node.

In some other embodiments, the meteorological modelling module is configured to determine the atmospheric delays of the navigation satellite system signals between two more navigation satellites and the infrastructure network node, and calculate the atmospheric quantity between the two or more navigation satellites and the infrastructure network node based on the determined atmospheric delays of the navigation satellite system signals between the two or more navigation satellites and the infrastructure network node.

In some further embodiments, the meteorological modelling module is configured to determine the atmospheric delays of the navigation satellite system signals between two or more navigation satellites and two or more infrastructure network nodes, and calculate the atmospheric quantity between the two or more navigation satellites and the two or more infrastructure network nodes based on the determined atmospheric delays of the navigation satellite system signals between the two or more navigation satellites and the two or more infrastructure network nodes.

In some embodiments, the meteorological modelling module is configured to determine the atmospheric delays of the navigation satellite system signals between one or more navigation satellites and one or more infrastructure network nodes located in a predetermined geographical area, and calculate the atmospheric quantity between the one or more navigation satellites and the one or more infrastructure network nodes located in the predetermined geographical area based on the determined atmospheric delays of the navigation satellite system signals between the one or more navigation satellites and the one or more infrastructure network nodes.

In some other embodiments, the meteorological modelling module is configured to determine the atmospheric delays of the navigation satellite system signals between one or more navigation satellites and one or more fixed infrastructure network nodes located in a predetermined geographical area, and calculate the atmospheric quantity between the one or more navigation satellites and the one or more fixed infrastructure network nodes located in the predetermined geographical area based on the determined atmospheric delays of the navigation satellite system signals between the one or more navigation satellites and the one or more fixed infrastructure network nodes.

In some embodiments, the atmospheric delay comprises ionospheric delay and tropospheric delay.

In some other embodiments, the atmospheric delay comprises only tropospheric delay.

In some further embodiments, the atmospheric delay comprises only ionospheric delay.

In some embodiments, the meteorological modelling module is configured to calculate theoretical ionospheric delay based on the navigation satellite system signal having the first frequency and the navigation satellite system signal having the second frequency received in the infrastructure network node from the navigation satellite.

In some other embodiments, the meteorological modelling module is configured to determine overall atmospheric delay of the navigation satellite signal between the navigation satellite and the infrastructure network node, calculate theoretical ionospheric delay based on the navigation satellite system signal having the first frequency and the navigation satellite system signal having the second frequency received in the infrastructure network node from the navigation satellite, subtract the theoretical ionospheric delay from the overall atmospheric delay to generate an ionospheric delay free navigation satellite system signal, and determine a tropospheric delay of the navigation satellite system signal based on the ionospheric delay free navigation satellite system signal.

In some further embodiments, the meteorological modelling module is configured to determine overall atmospheric delay of the navigation satellite signal between the navigation satellite and the infrastructure network node, calculate theoretical ionospheric delay based on the navigation satellite system signal having the first frequency and the navigation satellite system signal having the second frequency received in the infrastructure network node from the navigation satellite, subtract the theoretical ionospheric delay from the overall atmospheric delay to generate an ionospheric delay free navigation satellite system signal, determine a tropospheric delay of the navigation satellite system signal based on the ionospheric delay free navigation satellite system signal, and determine effective ionospheric delay by subtracting the determined tropospheric delay from the overall atmospheric delay.

The present invention is further based on the idea of providing a method for meteorological modelling, characterized in that the method being carried out in connection with an infrastructure network comprising a plurality of separate infrastructure network nodes provided over a geographical area. The method comprises:
carrying out data exchange in the infrastructure network,
receiving navigation satellite system signals from the navigation satellites of the global navigation satellite system in the infrastructure network nodes, and
controlling operation of the infrastructure network nodes based on the received navigation satellite system signals,

The method further comprises:
determine atmospheric delays of the navigation satellite system signals between the navigation satellites and the infrastructure network nodes based on the received navigation satellite system signals, and
calculating atmospheric quantity between the navigation satellites and the infrastructure network nodes based on the determined atmospheric delays of the navigation satellite system signals between the navigation satellites and the infrastructure network nodes.

In some embodiments, the method comprises receiving, in the infrastructure network node, navigation satellite system signals from two or more navigation satellites, respectively; or

In some other embodiments, the method comprises receiving, in two or more infrastructure network nodes, a navigation satellite system signal from a navigation satellite, respectively; or

In some further embodiments, the method comprises receiving, in two or more infrastructure network nodes, navigation satellite system signals from two or more navigation satellites.

In some embodiments, the method comprises receiving, in the infrastructure network node, navigation satellite system signals from the navigation satellites of two or more global navigation satellite systems.

In some embodiments, the method comprises receiving navigation satellite system signals from the navigation satellites in at least two different frequencies.

In some embodiments, the method comprises determining Tropospheric Delay of the navigation satellite signal between the navigation satellite and the infrastructure network node based on the navigation satellite system signal received in the infrastructure network node.

In some other embodiments, the method comprises determining Tropospheric Delay of the navigation satellite system signals between two or more navigation satellites and the infrastructure network node based on the navigation satellite system signals received in the infrastructure network node; or

In some further embodiments, the method comprises determining Tropospheric Delay of the navigation satellite signal between the navigation satellite and the infrastructure network node based on the navigation satellite signal received in infrastructure network node, and further Wet Delay of the navigation satellite signal between the navigation satellite and the infrastructure network node based on the determined Tropospheric Delay; or

In some yet further embodiments, the method comprises determining Tropospheric Delay of the navigation satellite system signals between two or more navigation satellites and the infrastructure network node based on the navigation satellite system signals received in the infrastructure network node, and further Wet Delay of the navigation satellite system signals between the two or more navigation satellites and the infrastructure network node based on the determined Tropospheric Delay.

In some embodiments, the method comprises determining a three-dimensional water vapor distribution in the atmosphere based on the navigation satellite system signals received in the infrastructure network node from two or more navigation satellites by global navigation satellite system tomography.

In some other embodiments, the method comprises determining three-dimensional water vapor distribution in the atmosphere based on the determined Tropospheric Delay or Wet Delay of the navigation satellite system signals between the two or more navigation satellites and the infrastructure network node by global navigation satellite system tomography.

In some embodiments, the method comprises determining the atmospheric delays of the navigation satellite system signals between the navigation satellite and two or more infrastructure network nodes, and calculating the atmospheric quantity between the navigation satellite and the two or more infrastructure network nodes based on the determined atmospheric delays of the navigation satellite system signals between the navigation satellite and the two or more infrastructure network node.

In some other embodiments, the method comprises determining the atmospheric delays of the navigation satellite system signals between two more navigation satellites and the infrastructure network node, and calculating the atmospheric quantity between the two or more navigation satellites and the infrastructure network node based on the determined atmospheric delays of the navigation satellite system signals between the two or more navigation satellites and the infrastructure network node.

In some further embodiments, the method comprises determining the atmospheric delays of the navigation satellite system signals between two or more navigation satellites and two or more infrastructure network nodes, and calculating the atmospheric quantity between the two or more navigation satellites and the two or more infrastructure network nodes based on the determined atmospheric delays of the navigation satellite system signals between the two or more navigation satellites and the two or more infrastructure network nodes.

In some embodiments, the method comprises determining the atmospheric delays of the navigation satellite system signals between one or more navigation satellites and one or more infrastructure network nodes located in a predetermined geographical area, and calculating the atmospheric quantity between the one or more navigation satellites and the one or more infrastructure network nodes located in the predetermined geographical area based on the determined atmospheric delays of the navigation satellite system signals between the one or more navigation satellites and the one or more infrastructure network nodes.

In some other embodiments, the method comprises determining the atmospheric delays of the navigation satellite system signals between one or more navigation satellites and one or more fixed infrastructure network nodes located in a predetermined geographical area, and calculating the atmospheric quantity between the one or more navigation satellites and the one or more fixed infrastructure network nodes located in the predetermined geographical area based on the determined atmospheric delays of the navigation satellite system signals between the one or more navigation satellites and the one or more fixed infrastructure network nodes.

In some embodiments, the method comprises carrying out global navigation satellite system tomography between two or more navigation satellites and one or more infrastructure network nodes based on the navigation satellite system signals received in the one or more infrastructure network nodes.

In some other embodiments, the method comprises carrying out global navigation satellite system tomography, the global navigation satellite system tomography comprising determining atmospheric delays between two or more navigation satellites and one or more infrastructure network nodes, and calculating one or more atmospheric quantities between two or more navigation satellites and one or more infrastructure network nodes based on the determined atmospheric delays; or

In some further embodiments, the method comprises carrying determining a three-dimensional distribution of the one or more atmospheric quantities in the atmosphere based on the navigation satellite system signals received in the navigation satellite system modules of the one or more infrastructure network nodes from two or more navigation satellites by global navigation satellite system tomography.

In some embodiments the method is carried out with a system as disclosed above. Thus, the operation of the system is interchangeable to method and method steps thereof.

An advantage of the system and method of the invention is that the accuracy of numerical weather predictions and forecasts, as well as global weather analyses are very likely to increase. Significantly increased coverage of and availability of atmospheric data collected from GNSS receivers is achieved when infrastructure network nodes having GNSS receivers for primary network control purposes are utilized in GNSS meteorology. The increased coverage and availability have significant effect on weather forecasts and climate monitoring in all areas covered by infrastructure networks, especially when they are telecommunication networks such as 5G or future telecommunication networks. This significantly increased coverage and availability will enable hyperlocal weather forecasts for any region where GNSS meteorology measurement are available via the infrastructure network and nodes thereof.

### BRIEF DESCRIPTION OF THE DRAWINGS

The invention is described in detail by means of specific embodiments with reference to the enclosed drawings, in which

FIG. 1 shows schematically a basic global navigation satellite system;

FIGS. 2 to 4 show schematically different embodiments of the present invention;

FIG. 5 to 7 are schematic diagrams showing embodiments of a hardware configuration of a system according to the present invention;

FIG. 8 is a schematic configuration of one embodiment of a software module operating a system according to the present invention;

FIG. 9 shows schematically a navigation satellite system receiver, and

FIGS. 10 to 12 show schematically methods for determining atmospheric meteorological conditions.

### DETAILED DESCRIPTION OF THE INVENTION

Systems and methods described in the context of this application comprise and utilize global navigation satellite systems (GNSS) for meteorological modelling and calculations. In the context of this application the GNSS may be known GNSS such as Global Positioning System (GPS), Russian Global Navigation Satellite System (GLONASS), the European Satellite Navigation System (Galileo), Immarsat, Chinese Navigation Satellite System (BeiDou), Indian Regional Navigation Satellite System (IRNSS), Japanese Quasi-Zenith Satellite System (QZSS), Multi-functional Satellite Augmentation System (MTSAT or MSAS) as well as Satellite Based Augmentation System (SBAS) and Regional Satellite Systems. Accordingly, the present invention may be carried out by utilizing existing and future GNSS.

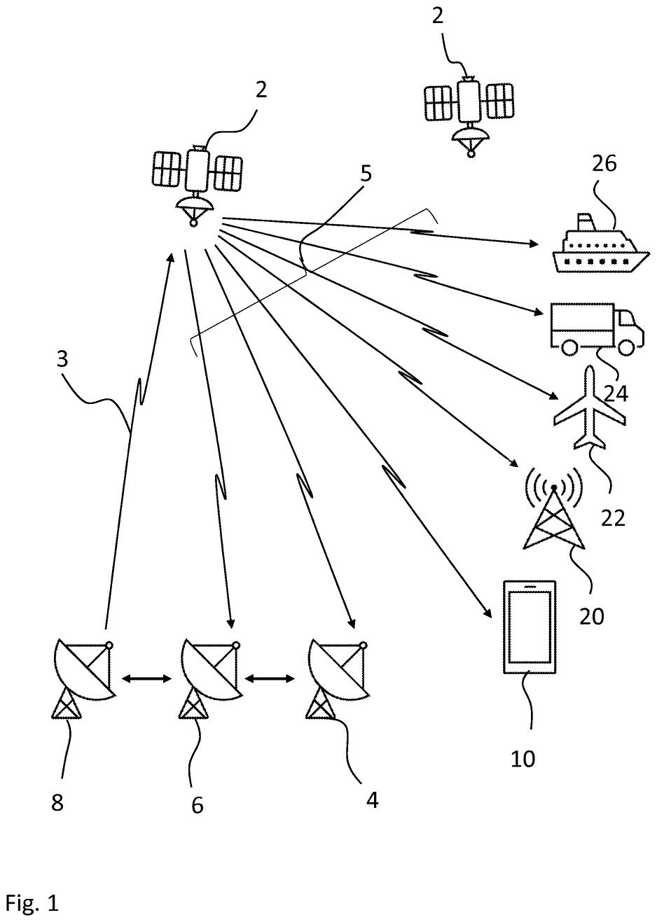

FIG. 1 shows schematically a general GNSS architecture. The GNSS architecture comprises three major components: a space segment, a control segment and client segment.

The client segment may also be denoted as user segment. Different navigation satellite systems may also be denoted as different navigation satellite constellations.

The space segment comprises global navigation system satellites (GNSS satellites) 2, orbiting about 20,000 km above the earth surface. Each GNSS satellite broadcasts a global navigation satellite system signal (GNSS signal) 5 that identifies it and provides its time, orbit and status.

The control segment comprises a ground-based network of master control stations 6, data uploading stations 8 and monitoring stations 4. For example, in the case of GPS, the system comprises two master control stations 6, four data uploading stations 8 and 16 monitoring stations 4, located throughout the world.

In each GNSS system, the master control station 6 adjusts orbit parameters and onboard high-precision clocks of the satellites 2 when necessary to maintain accuracy.

Monitor stations 4 are usually installed over a broad geographic area, monitor signals and status of the satellites 2, and transmit this information to the master control station 6. The master control station 6 analyses the signals then transmits orbit and time corrections to the satellites 2 through data uploading stations 8.

The client segment consists of equipment, devices and systems 10, 20, 22, 24, 26 that processes the received navigation satellite system signals 5 from the GNSS satellites 2 and utilize them to derive and apply location and time information. The equipment, devices and systems comprise smartphones and other mobile devices and handheld devices 10 comprising GNSS receivers. The equipment, devices and systems further comprise vehicles, such as airplanes 22, cars 24 and ships 26, provided with GNSS receivers. The equipment, devices and systems further comprise fixed ground-based infrastructure networks 20 comprising infrastructure network nodes provided with GNSS receivers. The fixed ground-based infrastructure networks 20 comprise for example telecommunication networks, power and electricity networks, road and railroad infrastructure networks, lighting networks, district heating and cooling networks, and the like.

Both the fixed infrastructure networks 20 and the mobile or movable equipment and devices 10, 22, 24, 26 provide an infrastructure network comprising infrastructure network nodes provided with a navigation satellite system module having a navigation satellite system receiver. The infrastructure network nodes further comprise an infrastructure network communication module configured carry out data exchange in the infrastructure network.

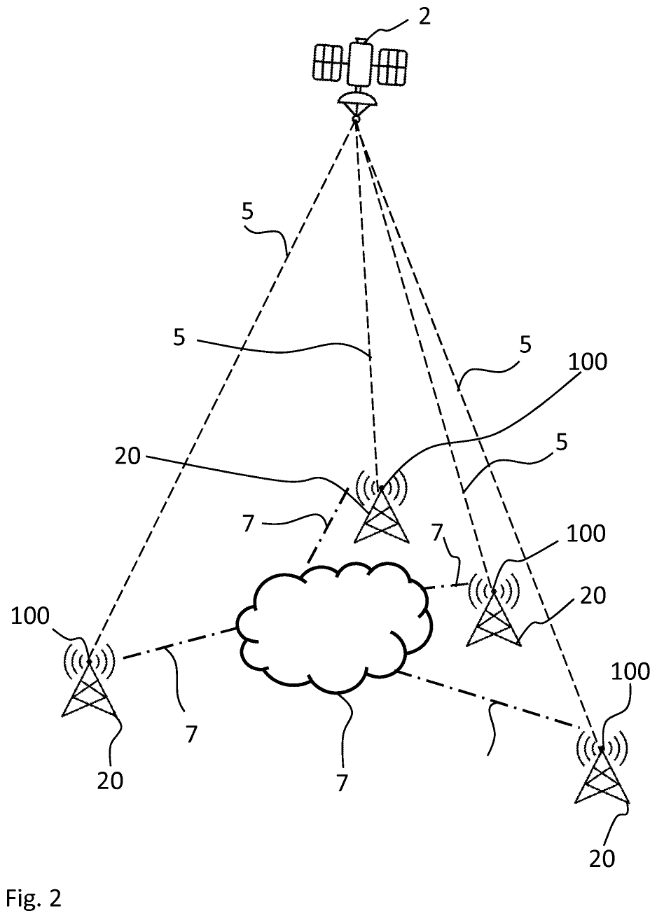

FIG. 2 shows schematically a fixed telecommunication network comprising telecommunication network base stations 20 as the infrastructure network nodes at fixed geographical locations. The telecommunication network base stations 20 have fixed geographical locations and associated GNSS coordinates. Thus, the geographical location of the fixed telecommunication network base stations 20 in the GNSS system is known.

In some embodiments, the telecommunication network is a mobile telecommunication network comprising mobile telecommunication network base stations 20 as the infrastructure network nodes at fixed geographical locations. The mobile telecommunication network may be a 3G, 4G, 5G, 6G or 7G telecommunication network comprising telecommunication network base stations 20 at fixed geographical locations.

The telecommunication network may also be wide area network (WAN), Metropolitan area network (MAN), Local area network (LAN) or any other fixed telecommunication network comprising interconnected fixed infrastructure network nodes.

The telecommunication network base stations 20 are provided with node elements 100 for operating the telecommunication network base stations 20. The node element 100 is configured to receive navigation satellite system signals 5 from navigation satellites, carry out data exchange and communication 7 in the telecommunication network and between the base stations 20, as well as control operation of the telecommunication network and the base stations 20 based on the received navigation satellite system signals 5.

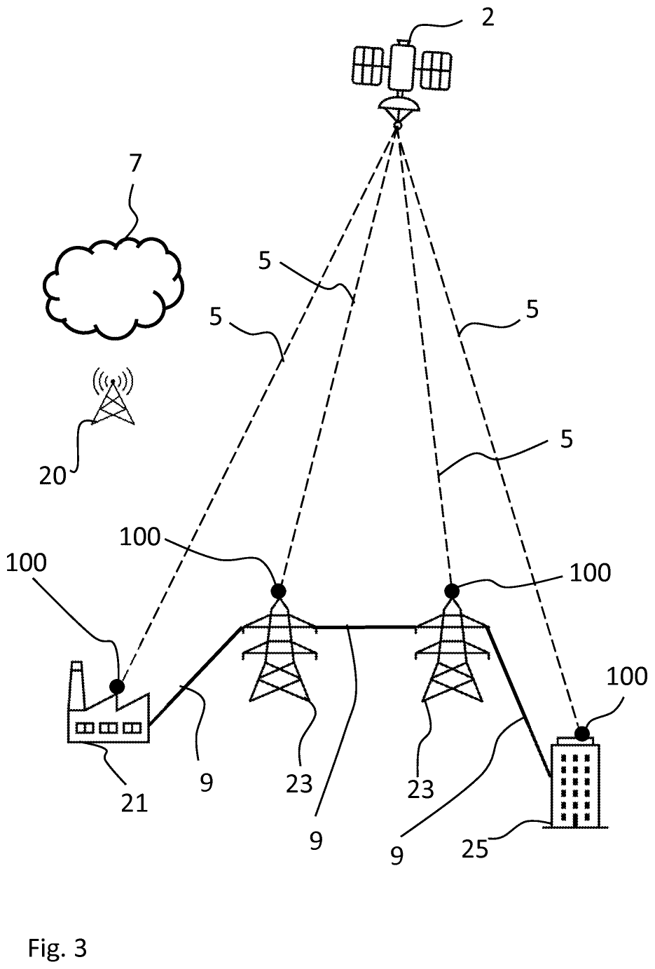

FIG. 3 shows schematically a fixed electricity network comprising electricity network stations 21, 23, 25 as the infrastructure network nodes at fixed geographical locations. The electricity network stations may comprise a power plant, electricity grid stations 23 and electricity user stations 25 connected to each other with power lines 9. The electricity network stations 21, 23, 25 have fixed geographical locations and associated GNSS coordinates. Thus, the geographical location of the fixed electricity network stations 21, 23, 25 in the GNSS system is known.

The electricity network stations 21, 23, 25 are provided with node elements 100 for operating or controlling the fixed electricity network and electricity network stations 21, 23, 25. The node element 100 is configured to receive navigation satellite system signals 5 from navigation satellites, carry out data exchange and communication in the electricity network and between the electricity network stations 21, 23, 25, as well as control operation of the electricity network and the electricity network stations 21, 23, 25 based on the received navigation satellite system signals 5.

The node element 100 may also be configured to be connected to the telecommunication network 7 and the telecommunication network base stations 20 thereof for carry out data exchange and communication in the electricity network and between the electricity network stations 21, 23, 25.

The general structure of the fixed electricity network may also be applied to district heating and cooling networks with similar fixed infrastructure network nodes.

The general structure of the fixed electricity network may also be applied to road and railroad infrastructure networks having fixed infrastructure network nodes such as cameras and sensors, like temperature sensors or motion sensors.

The general structure of the fixed electricity network may also be applied to lighting networks having fixed lighting devices as fixed infrastructure network nodes.

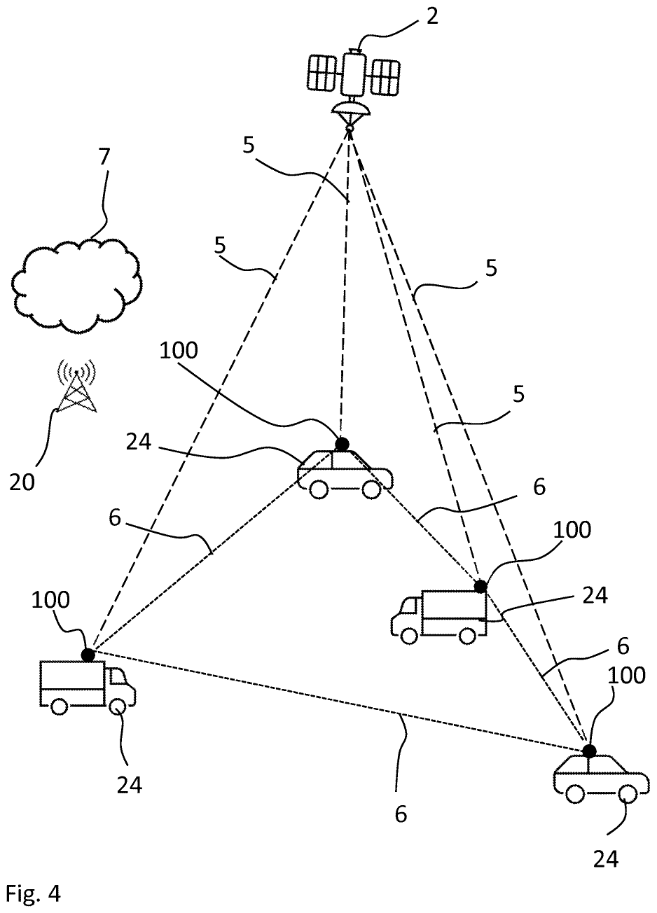

FIG. 4 shows a vehicle infrastructure network comprising vehicles infrastructure network nodes 24. The vehicle infrastructure nodes 24 are mobile infrastructure nodes without fixed geographical location and GNSS coordinates. The vehicle infrastructure nodes 24 are provided as the vehicles. Thus, the geographical location of the vehicle infrastructure nodes 24 changes and the geographical location is determined and updated by utilizing the navigation satellite system signals 5.

The vehicle infrastructure nodes 24 may be cars, as in FIG. 4, or trains, airplanes 22 or ships 26 or the like. In some embodiments, the vehicle infrastructure network comprises fixed road or railroad nodes.

The vehicle infrastructure nodes 24 are provided with node elements 100 for operating or controlling the vehicle infrastructure network and the vehicle infrastructure nodes 24. The node element 100 is configured to receive navigation satellite system signals 5 from navigation satellites, carry out data exchange and communication 6 in the vehicle infrastructure network and between the vehicle infrastructure nodes 24, as well as control operation of the vehicle infrastructure network and the vehicle infrastructure nodes 24 based on the received navigation satellite system signals 5.

The node element 100 may also be configured to be connected to the telecommunication network 7 and the telecommunication network base stations 20 thereof for carry out data exchange and communication in the vehicle infrastructure network and between the vehicle infrastructure nodes 24.

Accordingly, in some embodiments the infrastructure network is fixed infrastructure network comprising fixed infrastructure network nodes at fixed geographical locations. In alternative embodiments, the infrastructure network is a mobile client infrastructure network comprising mobile infrastructure network nodes or a vehicle infrastructure network comprising vehicle infrastructure network nodes. In some further embodiments, infrastructure network is a multi-client infrastructure network comprising both fixed infrastructure network nodes at fixed geographical locations, and mobile or vehicle infrastructure network nodes.

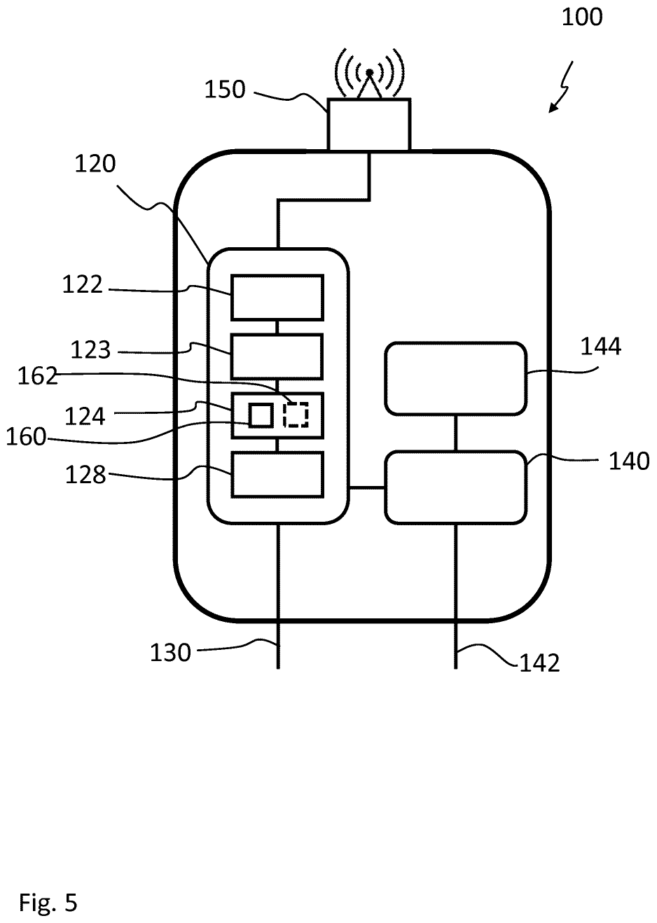

FIG. 5 shows schematically physical structure of the node element 100. The node element 10 comprises an antenna unit 150 configured receive the navigation satellite system signals 5.

In come embodiments the antenna unit 150 is configured to send and receive data in the infrastructure network and/or between the infrastructure network nodes.

The node element 100 comprises an operating unit 120. The operating unit 120 is connected to the antenna unit 150 for carrying out data exchange to and from the operating unit and for receiving navigation satellite system signals 5.

The operating unit 120 is further connected to a network core or control centre 130, at least in telecommunication networks.

The node element 100 further comprises a power unit 140 connected to power supply 142. The node element 100 also comprises a battery connected to the power unit 140 for backup. The battery 144 may also be omitted. The power unit 140 is connected to the operating unit 120 for providing power to the operating unit 120.

The operating unit 120 comprises an infrastructure network communication module 122 configured carry out data exchange in the infrastructure network.

The infrastructure network communication module 122 comprises for example 3G, 4G, 5G, 6G, 7G or beyond core or any other telecommunication core configured to carry out data exchange in the infrastructure network.

The operating unit 120 comprises a navigation satellite system module 124 having a navigation satellite system receiver 160, 162 configured to receive navigation satellite system signals 5 from the navigation satellites 2 of the global navigation satellite system.

The operating unit 120 further comprises an infrastructure network control module 123 configured to control the data exchange via the infrastructure network communication module 122 and to control operation of the infrastructure network node 20, 21, 22, 23, 24, 25, 26 based on the received navigation satellite system signals 5.

In the infrastructure network it is usually required that operation of the infrastructure network nodes 20, 21, 22, 23, 24, 25, 26 is coordinated and controlled such that the infrastructure network nodes 20, 21, 22, 23, 24, 25, 26 operate efficiently and in correct manner together in the infrastructure network. Therefore, timing and synchronization of the infrastructure network node 20, 21, 22, 23, 24, 25, 26 in the infrastructure network are required.

The infrastructure network control module 123 configured to control timing and synchronization of the infrastructure network node 20, 21, 22, 23, 24, 25, 26 in the infrastructure network based on the navigation satellite system signals 5 with the navigation satellite system module 124.

GNSS satellites provide x, y, z coordinates and precise time information to the receiver. Fundamentals of any GNSS system is that all satellite clocks are synchronized with precise time. The navigation satellites 2 broadcast coded navigation satellite system signals 5 at exact times while the receivers 160, 162 estimates the exact time it takes for each navigation satellite system signal 5 to travel from the navigation satellite 2 to the receiver 160, 162. The position of the GNSS receiver 160, 162 is then calculated as a function of the time of flight of each navigation satellite system signal 5 from the navigation satellite 2 to the receiver 160, 162. Therefore, the navigation satellite system signals 5 are used for timing and synchronization of operation of the infrastructure network nodes 20, 21, 22, 23, 24, 25, 26 in the infrastructure network. Thus, the infrastructure network nodes 20, 21, 22, 23, 24, 25, 26 in the infrastructure network are configured to utilize the navigation satellite system signals 5 for operating the infrastructure network nodes 20, 21, 22, 23, 24, 25, 26 and the infrastructure network in efficient manner such that errors may be prevented.

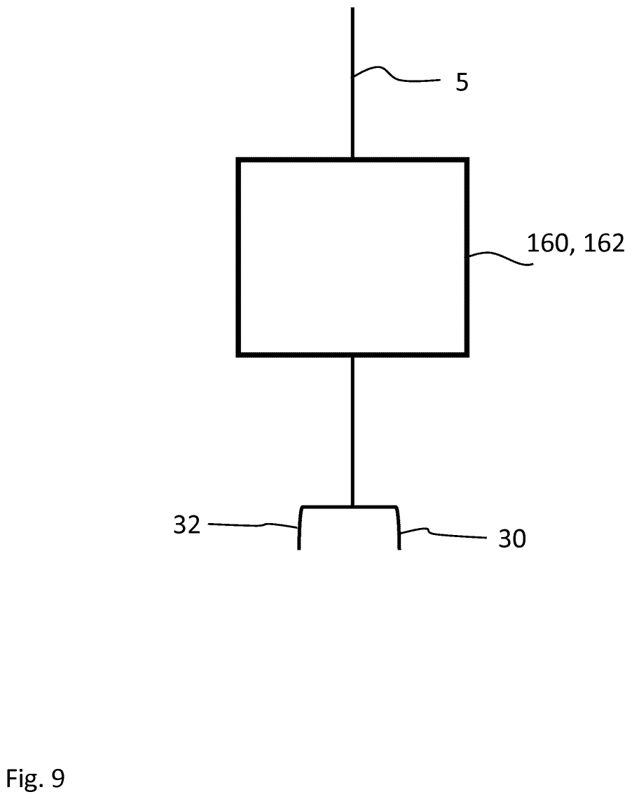

FIG. 9 shows schematically a GNSS receiver 160, 162. The GNNS receiver is configured to generate navigation output messages 30 which location information and precise time information. The infrastructure network control module 123 is configured to control timing, or synchronization, or timing and synchronization of the infrastructure network node 20, 21, 22, 23, 24, 25, 26 in the infrastructure network based on the navigation output messages 30 generated by the navigation satellite system receiver 160, 162. The navigation output messages mean navigation output data comprising location and time data.

The navigation satellite system receiver 160, 162 is further configured to generate signal characteristic output messages 32. The signal characteristic output messages comprise information of the navigation satellite signal 5 itself, as received from each navigation satellite at each frequency. The signal characteristic output messages comprise for example carrier phase information, code phase information, pseudoranges information and pseudorange rates information. The meteorological modelling module 128 is configured to calculate the atmospheric delay based on the signal characteristics output messages 32 generated by the navigation satellite system receiver 160, 162. The signal characteristics output messages mean navigation satellite system raw signal data.

The system of the present invention further comprises a meteorological modelling module 128. The meteorological modelling module 128 is configured to determine atmospheric delay of the navigation satellite signal 5 between the navigation satellite 2 and the infrastructure network node 20, 21, 22, 23, 24, 25, 26. The meteorological modelling module 128 is further configured to calculate atmospheric quantity in a direction between the navigation satellite 2 and the infrastructure network node 20, 21, 22, 23, 24, 25, 26 based on the determined atmospheric delay of the navigation satellite signal between the navigation satellite 2 and the infrastructure network node 20, 21, 22, 23, 24, 25, 26.

As shown in FIG. 5, the meteorological modelling module 128 is provided to the node element 100 of the infrastructure network node 20, 21, 22, 23, 24, 25, 26. The meteorological modelling module 128 is arranged to receive the navigation satellite system signals 5, or data representing the navigation satellite system signals 5, from the navigation satellite system module 124.

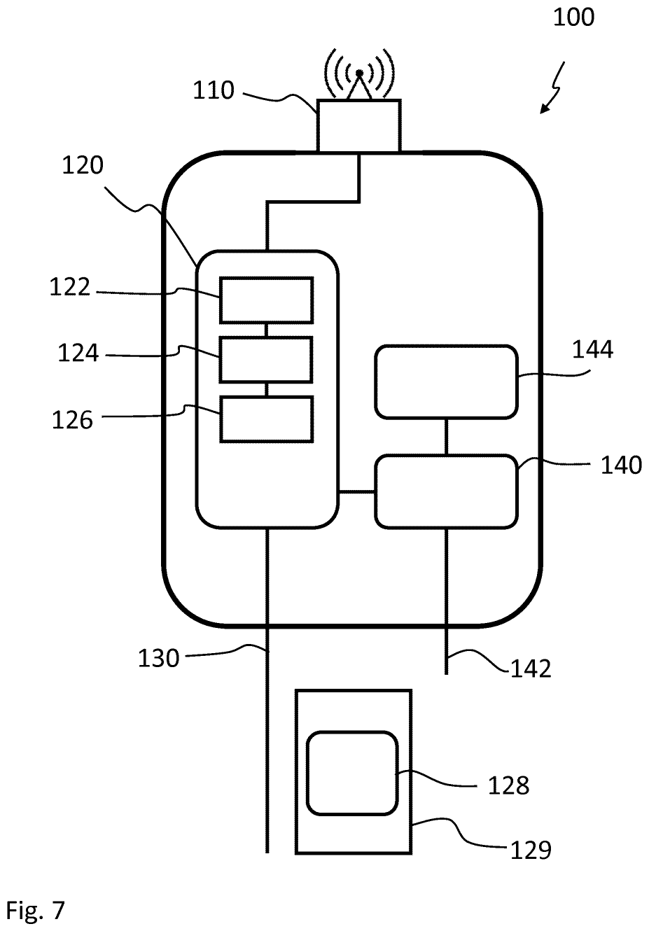

FIG. 7 shows an alternative embodiment in which the system comprises an external meteorological modelling server 129 arranged in data exchange connection with the infrastructure network nodes 20, 21, 22, 23, 24, 25, 26 of the infrastructure network. The meteorological modelling module 128 is provided to the external meteorological modelling server 129. The external meteorological modelling server 129 is connected to the infrastructure network nodes 20, 21, 22, 23, 24, 25, 26 via a telecommunication network. The external meteorological modelling server 129 is connected to the infrastructure network nodes 20, 21, 22, 23, 24, 25, 26 via the infrastructure network communication module 122.

Thus, the external meteorological modelling server 129 is connected to the infrastructure network nodes 20, 21, 22, 23, 24, 25, 26 via the telecommunication network and arranged to receive the navigation satellite system signals 5, or data representing the navigation satellite system signals 5, from the navigation satellite system modules 124 of the infrastructure network nodes 20, 21, 22, 23, 24, 25, 26.

In a further alternative embodiment, the system is provided as distributed system in which the meteorological modelling module 128 and operation thereof is distributed between the infrastructure network nodes 20, 21, 22, 23, 24, 25, 26 and an external meteorological modelling server 129 arranged in data exchange connection with the infrastructure network nodes 20, 21, 22, 23, 24, 25, 26 of the infrastructure network.

In one embodiment, a first sub-module of the meteorological modelling module 128 is provided to and carried out in the infrastructure network nodes 20, 21, 22, 23, 24, 25, 26. The first sub-module of the meteorological modelling module 128 is configured to determine atmospheric delay of the navigation satellite signal 5 between the navigation satellite 2 and the infrastructure network node 20, 21, 22, 23, 24, 25, 26.

A second sub-module of the meteorological modelling module 128 is provided to and carried out in the external meteorological modelling server 129. The second sub-module of the meteorological modelling module 128 is configured to calculate atmospheric quantity in a direction between the navigation satellite 2 and the infrastructure network node 20, 21, 22, 23, 24, 25, 26 based on the determined atmospheric delay of the navigation satellite signal between the navigation satellite 2 and the infrastructure network node 20, 21, 22, 23, 24, 25, 26.

In some embodiments, the meteorological modelling module 128 is further configured to generate a meteorological model based on the calculate atmospheric quantities. The meteorological model comprising the calculated atmospheric quantities.

In some embodiments, the meteorological modelling module 128 is further configured to determine geographical location of each of the infrastructure network nodes 20, 21, 22, 23, 24, 25, 26 based on the navigation satellite signals 5 received in each of the infrastructure network nodes 20, 21, 22, 23, 24, 25, 26, respectively. The meteorological modelling module 128 is further configured to associate the determined geographical locations of the infrastructure network nodes 20, 21, 22, 23, 24, 25, 26 with the calculated atmospheric quantities. The meteorological model comprising the calculated atmospheric quantities associated with geographical location information. Thus, a location-based meteorological model is generated.

In an alternative embodiment, the system comprises one or more pre-determined meteorological models, and the meteorological modelling module 128 is further configured to update the one or more pre-determined meteorological models based on the calculated atmospheric quantities.

The geographical location information is associated to the one or more pre-determined meteorological models and also to the calculated atmospheric quantities such that location-based updating is carried out.

Generating the meteorological model or updating the one or more meteorological models is carried in the meteorological modelling module 128 in the operating unit 120 of node element 100, or in the external meteorological modelling server 129 or in the second sub-module of the meteorological modelling module 128.

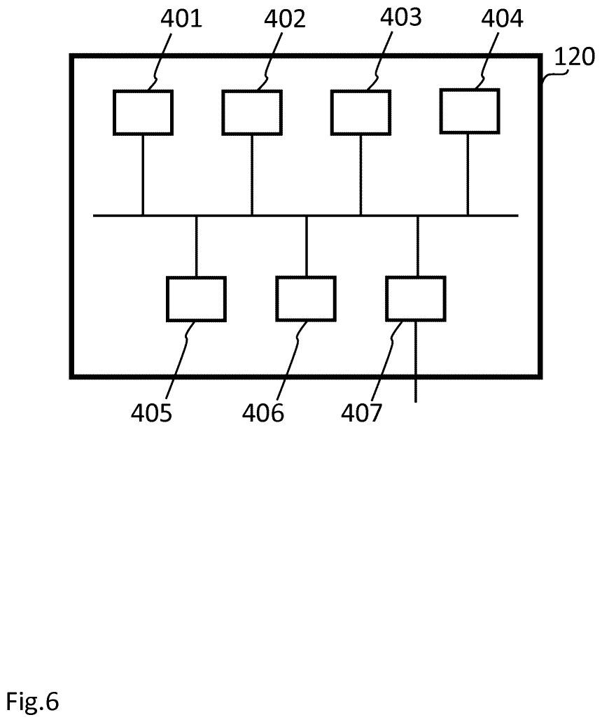

FIG. 6 is a schematic diagram illustrating a hardware configuration of an apparatus for implementing the operating unit 120 of the node element 100. The apparatus illustrated in FIG. 6 includes components from a central processing unit (CPU) 401 to an I/F 407. The CPU 401 directly or indirectly controls each device (a read only memory (ROM), a random access memory (RAM), etc.) connected by an internal bus and executes a program and instructions for implementing the present invention. A basic input output system (BIOS) is stored in the ROM 402.

A RAM 403 is used as a work area of the CPU 401 or used as a temporary storage apparatus for loading a software module for implementing the present invention. A hard disk drive (HDD) 404 stores an operating system (OS) which is basic software or a software module. A solid state drive (SSD) may be provided instead of the HDD 404.

An input apparatus 405 inputs data from the antenna unit 150 and via the infrastructure network communication module 122 and the navigation satellite system module 124. The input apparatus 405 comprises receiver of the infrastructure network and the navigation satellite navigation satellite system receiver 160, 162. An output apparatus 406 outputs data. The output apparatus comprises a transmitter of the infrastructure network or the telecommunication network. The I/F is an interface for connecting to the infrastructure network or the telecommunication network. After the apparatus is activated, the BIOS is executed by the CPU 401 and the OS is loaded from the HDD 404 to the RAM 403 so that the OS is executable. The CPU 401 loads various software modules from the HDD 404 to the RAM 403 according to an operation of the OS at any time so that the software modules are executable. Various types of software modules are executed and operated by the CPU 401. In addition, the I/F 407 is controlled by the CPU 401 according to the operation of the OS and implements communication with the infrastructure network or the telecommunication network.

The software modules comprise at least the infrastructure network control module 123.

As disclosed above, in some embodiments the software modules comprise at least the infrastructure network control module 123 and the meteorological modelling module 128 or the first sub-module thereof.

Navigation satellite system signals 5 pass through space from the navigation satellites 2 to the navigation satellite system receivers 160, 162. Most of space is near vacuum. To calculate accurate position, the receiver needs to know the length and direct path of the navigation satellite system signals 5 from the navigation satellites 2 to the navigation satellite system receivers 160, 162 and the infrastructure network nodes. Radio waves do not travel in a straight path. Navigation satellite system signals 5 travelling from the navigation satellite 2 to the navigation satellite system receivers 160, 162 are bent as they pass through the different layers during the travel. This bending has an effect and increase to the amount of time the navigation satellite system signal 5 travels from the navigation satellite to the navigation satellite system receivers 160, 162.

By comparing a straight line of sight to the actual path the signal travels one can determine how much atmosphere and different atmospheric variables affect the navigation satellite system signal 5. The meteorological modelling module 128 utilizes characteristics of the navigation satellite system signal 5 to calculate the amount of water vapor, pressure and temperature in the atmosphere.

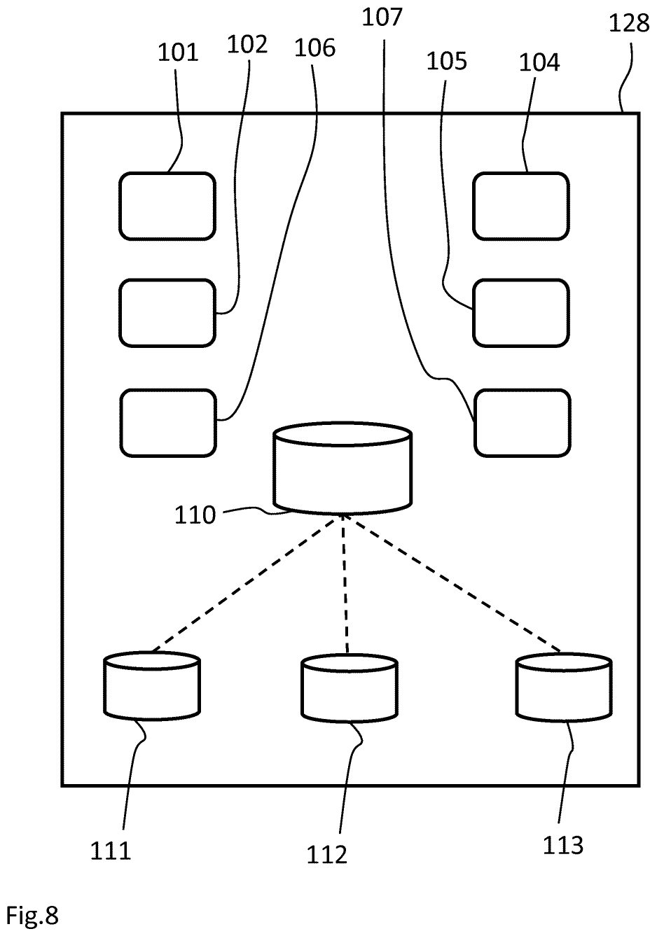

FIG. 8 shows a schematic configuration example of the meteorological modelling module 128. The meteorological modelling module 128 comprises components from an input unit 101 to an output unit 107.

The input unit 101 is configured to receive the navigation satellite system signals 5 or data representing the navigation satellite system signals 5.

A Zenith Tropospheric Delay unit 102 is configured to determine Zenith Tropospheric Delay of the navigation satellite signals 5 between the navigation satellite 2 and the infrastructure network node 20, 21, 22, 23, 24, 25, 26 based on the navigation satellites system signals 5 received in the navigation satellite system module 124.

The Zenith Tropospheric Delay unit 102 comprises a Zenith Tropospheric Delay calculation algorithm configured to calculated Zenith Tropospheric Delay based on the navigation satellites system signals 5. The navigation satellites system signals 5 are input to the Zenith Tropospheric Delay calculation algorithm. Output of the Zenith Tropospheric Delay calculation algorithm is Zenith Tropospheric Delay between the navigation satellite 2 and the infrastructure network node 20, 21, 22, 23, 24, 25, 26.

In some embodiments, Zenith Tropospheric Delay unit 102 is further configured to calculate Zenith Wet Delay of the navigation satellite system signals 5 between the two or more navigation satellites 2 and the infrastructure network node 20, 21, 22, 23, 24, 25, 26 based on the determined Zenith Tropospheric Delay. The navigation satellite system signals 5 are refracted nondispersively by the atmosphere (troposphere and stratosphere), with the signal delays at particular elevation angles and azimuths are mapped to form the Zenith Tropospheric Delay (ZTD). The ZTD can be attributed to the hydrostatic and the nonhydrostatic components of the atmosphere, which are mapped to the zenith using separate hydrostatic and wet mapping algorithms. Because of the well-mixed nature of the hydrostatic gases in the atmosphere, a Zenith Hydrostatic Delay (ZHD) can be accurately calculated using local surface pressure and temperature measurements. The additional delay resulting from the water vapor is the Zenith Wet Delay (ZWD). Therefore, the Zenith Wet Delay is calculated by subtracting the Zenith Hydrostatic Delay from the Zenith Tropospheric Delay.

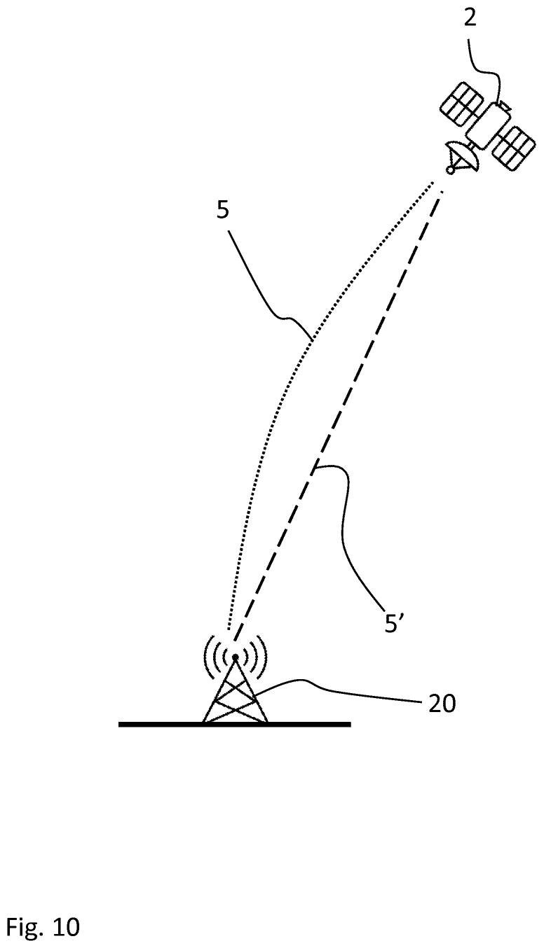

FIG. 10 shows schematically the bending of the navigation satellite system signal 5 between the navigation satellites 2 and the infrastructure network node 20, 21, 22, 23, 24, 25, 26. The linear line 5′represents direct line from the navigation satellite 2 to the and the infrastructure network node 20, 21, 22, 23, 24, 25, 26, and the curved line 5 represent the real path of the navigation satellite system signal 5.

An atmospheric quantity unit 104 is configured to calculate atmospheric quantity in a direction between the navigation satellite 2 and the infrastructure network node 20, 21, 22, 23, 24, 25, 26 based on the determined atmospheric delay of the navigation satellite signal between the navigation satellite 2 and the infrastructure network node 20, 21, 22, 23, 24, 25, 26.

The atmospheric quantity unit 104 comprises an atmospheric quantity calculation algorithm configured to calculated one or more atmospheric quantities based on the determined atmospheric delay of the navigation satellite signal between the navigation satellite 2 and the infrastructure network node 20, 21, 22, 23, 24, 25, 26.

The atmospheric quantity is one or more of temperature, pressure and humidity in the atmosphere.

The atmospheric quantity unit 104 comprises an atmospheric temperature calculation algorithm configured to calculate atmospheric temperature. In another embodiment atmospheric quantity unit 104 comprises an atmospheric pressure calculation algorithm configured to calculate atmospheric temperature. In a further embodiment atmospheric quantity unit 104 comprises an atmospheric humidity calculation algorithm configured to calculate atmospheric humidity.

In a yet further embodiment atmospheric quantity unit 104 comprises an atmospheric quantity calculation algorithm configured to calculate one or more of atmospheric humidity, atmospheric temperature, atmospheric pressure and atmospheric wind.

The determined atmospheric delay is input to the atmospheric quantity calculation algorithm. Output of the atmospheric quantity calculation algorithm is value representing the atmospheric quantity in the atmosphere in the direction between the navigation satellite 2 and the infrastructure network node 20, 21, 22, 23, 24, 25, 26.

In some embodiments, the atmospheric delay inputted to the atmospheric quantity calculation algorithm is the Zenith Wet Delay or the Zenith Tropospheric Delay. In some further embodiments, the atmospheric delay inputted to the atmospheric quantity calculation algorithm comprises both the Zenith Wet Delay or the Zenith Tropospheric Delay.

A Tomography unit 105 is configured to determine three-dimensional water vapor distribution in the atmosphere based on the navigation satellite system signals 5 received in the navigation satellite system module 124 from two or more navigation satellites 2.

The Tomography unit 105 comprises a Tomography calculation algorithm configured to calculate atmospheric water vapor between the navigation satellite 2 and the infrastructure network nodes based on the navigation satellite signals 5 received in the infrastructure network nodes.

In some embodiments, the determined atmospheric delay is input to the Tomography calculation algorithm. Output of the Tomography calculation algorithm is a three-dimensional water vapor model representing three-dimensional distribution of water vapor in the atmosphere.

In some embodiments, the atmospheric delay inputted to the Tomography calculation algorithm is the Zenith Wet Delay or the Zenith Tropospheric Delay. In some further embodiments, the atmospheric delay inputted to the Tomography calculation algorithm comprises both the Zenith Wet Delay or the Zenith Tropospheric Delay.

In further embodiments, the output of the atmospheric quantity calculation algorithm is input to the Tomography calculation algorithm. Output of the Tomography calculation algorithm is a three-dimensional water vapor model representing three-dimensional distribution of water vapor in the atmosphere. Thus, the inputs are the values representing the atmospheric quantity in the atmosphere in the directions between the navigation satellites 2 and the infrastructure network nodes 20, 21, 22, 23, 24, 25, 26.

A modelling unit 106 is configured to generate the meteorological model based on the calculated atmospheric quantities or update the pre-determined meteorological models, as disclosed above. The meteorological model comprises one or more of the calculated atmospheric quantities. In some embodiments, the meteorological model comprises one or more of the calculated atmospheric quantities and/or the three-dimensional water vapor model representing three-dimensional distribution of water vapor in the atmosphere based on the Tomography unit 105.

An output unit 107 is configured to output the generated meteorological model from the meteorological modelling module 128.

The meteorological modelling module 128 comprises a database 110.

The database 110 comprises a navigation satellite system signal database 111 configured to store raw signal data of the received in the infrastructure network node 20, 21, 22, 23, 24, 25, 26.

The database 110 comprises a process database 112 configured to store output of one or more of the Zenith Tropospheric Delay unit 102, the atmospheric quantity unit 104 and the Tomography unit 105.

The database 110 comprises a model database 113 configured to store the meteorological models and/or the pre-determined meteorological models.

The system of the invention may comprise one or more different global navigation satellite systems. Therefore, the navigation satellite system module 124 comprises a multi-system navigation satellite system receiver 160, 162 configured to receive navigation satellite system signals 5 from the navigation satellites 2 of two or more global navigation satellite systems. Alternatively, the navigation satellite system module 124 comprises a first navigation satellite system receiver 160 configured to receive configured to receive navigation satellite system signals 5 from the navigation satellites 2 of a first global navigation satellite system, and a second navigation satellite system receiver 162 configured to receive configured to receive navigation satellite system signals 5 from the navigation satellites 2 of a second global navigation satellite system.

The navigation satellites 2 send navigation satellite system signal 5 in multiple different frequencies.

In some embodiments, the navigation satellite system receiver 160, 162 is a single frequency navigation satellite system receiver configured to receive navigation satellite system signals 5 from navigation satellites 2 on one frequency.

In some preferred embodiments, the navigation satellite system receiver 160, 162 is a dual-frequency navigation satellite system receiver configured to receive navigation satellite system signals 5 having a first frequency and navigation satellite system signals 5 having a second frequency.

In some other preferred embodiments, the navigation satellite system receiver 160, 162 is a multi-frequency navigation satellite system receiver configured to receive navigation satellite system signals 5 on multiple different frequencies.

In some other preferred embodiments, the navigation satellite system module 124 comprises a first frequency navigation satellite system receiver 160, 162 configured to receive navigation satellite system signals 5 having a first frequency, and a second frequency navigation satellite system receiver 160, 162 configured to receive navigation satellite system signals 5 having a second frequency.

In some embodiments, the global navigation satellite system module is configured to receive GPS signals, the GPS signals having at least two of frequency bands L1, L2 and L5.

In some other embodiments, the global navigation satellite system module is configured to receive Glonass system signals, the Glonass system signals having at least two of frequency bands G1, G2 and G3.

In some further embodiments, the global navigation satellite system module is configured to receive Galileo system signals, the Galileo system signals having at least two of frequency bands E1, E5a, E5b and E6.

In further embodiments, the global navigation satellite system module is configured to receive frequency bands L1, L2 and L5.

In some other embodiments, the global navigation satellite system module is configured to receive Glonass system signals, the Glonass system signals having at least two of frequency bands G1, G2, G3, E1, E5a, E5b, E6, L1, L2 and L5. In some other embodiments, the navigation satellite system module is configured to receive QZSS system signals, the QZSS system signals having at least two frequency bands L1 and L5.

The delay of navigation satellite system signals usually comprises ionospheric part and tropospheric part. Using multi-frequency, or dual-frequency receivers or two or more receivers, the ionospheric part of the delay may be removed. Ionospheric delay varies with frequency, so it impacts the various GNSS signals differently. By comparing the delays of two or more different frequencies the ionospheric part of the delay may be removed. Thus, the atmospheric quantities may be calculated more accurately. In the context of this application the atmospheric quantities and atmospheric delay relate to tropospheric quantities and tropospheric delay.

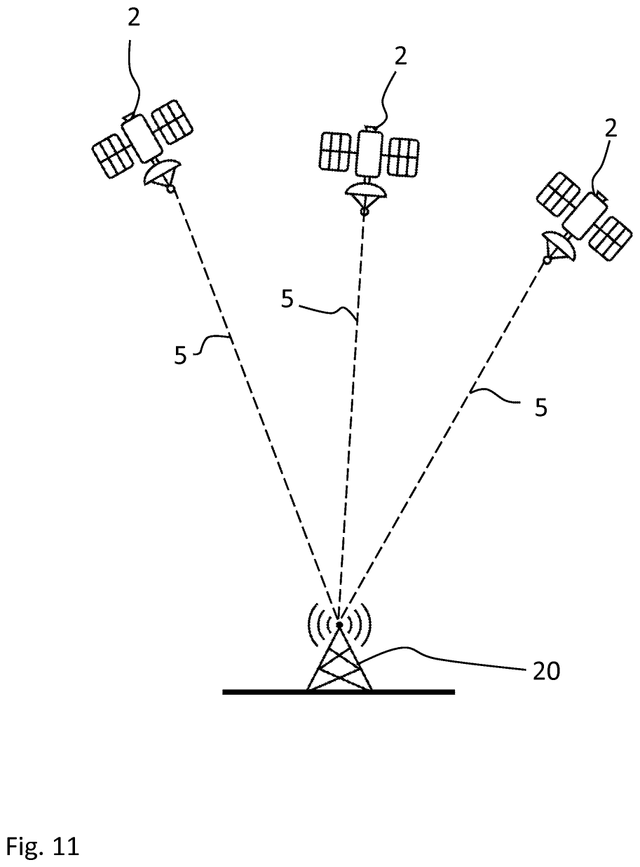

FIG. 11 shows schematically, that each of the infrastructure network nodes 20 is configured to receive navigation satellite system signals 5 from plurality of navigation satellites 2. Thus, the atmospheric quantities and the meteorological modelling is carried out in plurality of directions from each other the infrastructure network nodes 20.

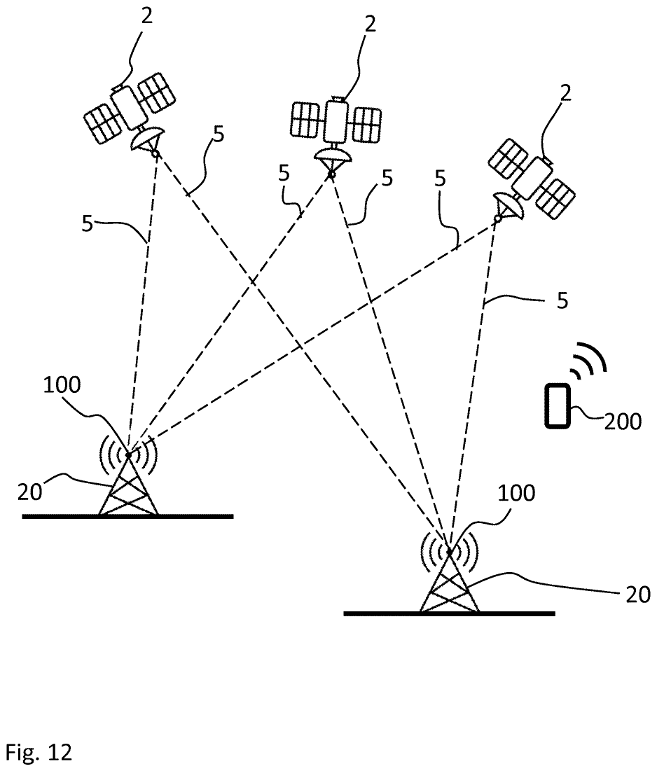

FIG. 12 further shows schematically multiple infrastructure network nodes 20 each of which is configured to receive navigation satellite system signals 5 from plurality of navigation satellites 2. Therefore, three-dimensional distribution of the atmospheric quantities is determined and also a three-dimensional meteorological model generated.

FIG. 12 further disclose that the system comprises one or more atmospheric sensors 200 arranged in communication connection with the meteorological modelling module 128. The sensors 200 may be temperature sensors, humidity sensors, pressure sensors or the like sensors. The sensors 200 may be connected with the meteorological modelling module 128 for example via a telecommunication network.

The meteorological modelling module 128 is configured to receive atmospheric measurement data from the one or more atmospheric sensors 200 and determine the three-dimensional distribution of the one or more atmospheric quantities in the atmosphere based on the navigation satellite system signals 5 and the atmospheric measurement data from the one or more atmospheric sensors 200.

In some embodiments, the meteorological modelling module 128 is configured to receive precise orbit data, or ephemeris, from an external ephemeris server, such as IGS. The ephemeris server is configured to determine or calculate precise orbit data of navigation satellites. The orbit data received with the navigation satellite system signals has minor inaccuracies which are eliminated by the calculations carried out by the ephemeris server. The meteorological modelling module 128 is configured to receive precise orbit data from the ephemeris server and determine the three-dimensional distribution of the one or more atmospheric quantities in the atmosphere based on the navigation satellite system signals 5 and the ephemeris data, and possible also with the atmospheric measurement data from the sensors 200.

The invention has been described above with reference to the examples shown in the figures. However, the invention is in no way restricted to the above examples but may vary within the scope of the claims.

1-28. (canceled)

29. A system for meteorological modelling, the system comprising global navigation satellite system comprising:
a space segment having navigation satellites,
a control segment having ground-based satellite stations, and
a client segment having a plurality of navigation satellite signal receiving client nodes, wherein the client segment comprises an infrastructure network comprising a plurality of separate infrastructure network nodes provided over a geographical area, the infrastructure network nodes comprising:
an infrastructure network communication module configured to carry out data exchange in the infrastructure network,
a navigation satellite system module having a navigation satellite system receiver configured to receive navigation satellite system signals from the navigation satellites of the global navigation satellite system, and
an infrastructure network control module configured to control data exchange via the infrastructure network communication module and to control operation of the infrastructure network node based on the received navigation satellite system signals, the system further comprising a meteorological modelling module configured to:
determine the atmospheric delay of the navigation satellite signal between the navigation satellite and the infrastructure network node, and
calculate an atmospheric quantity between the navigation satellite and the infrastructure network node based on the determined atmospheric delay of the navigation satellite signal between the navigation satellite and the infrastructure network node.

30. The system according to claim 29, wherein the system comprises two or more different global navigation satellite systems, and the navigation satellite system module comprises:
a multi-system navigation satellite system receiver configured to receive navigation satellite system signals from the navigation satellites of two or more global navigation satellite systems; or
a first navigation satellite system receiver configured to receive navigation satellite system signals from the navigation satellites of a first global navigation satellite system, and
a second navigation satellite system receiver configured to receive navigation satellite system signals from the navigation satellites of a second global navigation satellite system.

31. The system according to claim 29, wherein the infrastructure network is a fixed infrastructure network comprising fixed infrastructure network nodes at fixed geographical locations.

32. The system according to claim 31, wherein the infrastructure network is:
a fixed telecommunication network comprising telecommunication network base stations as the infrastructure network nodes at fixed geographical locations; or
a mobile telecommunication network comprising mobile telecommunication network base stations as the infrastructure network nodes at fixed geographical locations; or
a 3G, 4G, 5G, 6G or 7G telecommunication network comprising telecommunication network base stations as the infrastructure network nodes at fixed geographical locations.

33. The system according to claim 31, wherein the infrastructure network is:
an energy infrastructure network comprising energy control base stations as the infrastructure network nodes at fixed geographical locations; or
a road or railroad infrastructure network comprising road control base stations as the infrastructure network nodes at fixed geographical locations; or
a lighting infrastructure network comprising lighting control base stations as the infrastructure network nodes at fixed geographical locations.

34. The system according to claim 29, wherein the infrastructure network is a mobile client infrastructure network comprising mobile infrastructure network nodes; or a vehicle infrastructure network comprising vehicles infrastructure network nodes.

35. The system according to claim 31, wherein the infrastructure network is a multi-client infrastructure network comprising:
fixed infrastructure network nodes at fixed geographical locations, and
mobile infrastructure network nodes.

36. The system according to claim 31, wherein:
the navigation satellite system receiver is single frequency navigation satellite system receiver configured to receive navigation satellite system signals from navigation satellites on one frequency; or
the navigation satellite system receiver is a dual-frequency navigation satellite system receiver configured to receive navigation satellite system signals having a first frequency and navigation satellite system signals having a second frequency; or
the navigation satellite system receiver is a multi-frequency navigation satellite system receiver configured to receive navigation satellite system signals on multiple different frequencies; or
a navigation satellite system module comprises a first frequency navigation satellite system receiver configured to receive navigation satellite system signals having a first frequency, and
a second frequency navigation satellite system receiver configured to receive navigation satellite system signals having a second frequency.

37. The system according to claim 36, wherein:
the meteorological modelling module configured to determine atmospheric delay of the navigation satellite signal between the navigation satellite and the infrastructure network node based on the navigation satellite signal having the first frequency and the navigation satellite system signal having the second frequency; or
the meteorological modelling module configured to determine atmospheric delay of the navigation satellite signal between the navigation satellite and the infrastructure network node based on the navigation satellite system signals having different frequencies.

38. The system according to claim 29, wherein the navigation satellite system receiver is configured to generate signal characteristic output messages, and the meteorological modelling module is configured to calculate the atmospheric delay based on the signal characteristics output messages generated by the navigation satellite system receiver.

39. The system according to claim 29, wherein:
the meteorological modelling module is provided to the infrastructure network node; or
the system comprises an external meteorological modelling server arranged in data exchange connection with the infrastructure network nodes of the infrastructure network, the meteorological modelling module is provided to the external meteorological modelling server; or
the system is provided as distributed system in which the meteorological modelling module and operation thereof is distributed between the infrastructure network nodes and an external meteorological modelling server arranged in data exchange connection with the infrastructure network nodes of the infrastructure network.

40. A method for meteorological modelling, wherein the method being carried out in connection with an infrastructure network comprising plurality of separate infrastructure network nodes provided over a geographical area, the method comprising:
carrying out data exchange in the infrastructure network,
receiving navigation satellite system signals from the navigation satellites of the global navigation satellite system in the infrastructure network nodes, and
controlling operation of the infrastructure network nodes based on the received navigation satellite system signals,
the method further comprises:
determine atmospheric delays of the navigation satellite system signals between the navigation satellites and the infrastructure network nodes based on the received navigation satellite system signals, and
calculating atmospheric quantities between the navigation satellites and the infrastructure network nodes based on the determined atmospheric delays of the navigation satellite system signals between the navigation satellites and the infrastructure network nodes.

41. The method according to claim 40, wherein the method comprises:
receiving, in the infrastructure network node, navigation satellite system signals from two or more navigation satellites, respectively; or
receiving, in two or more infrastructure network nodes, a navigation satellite system signal a navigation satellite, respectively; or
receiving, in two or more infrastructure network nodes, navigation satellite system signals from two or more navigation satellites.

42. The method according to claim 40, wherein the method further comprises receiving navigation satellite system signals from the navigation satellites (10) in at least two different frequencies.

43. The method for meteorological modelling, wherein the method being carried out in connection with an infrastructure network comprising plurality of separate infrastructure network nodes provided over a geographical area, the method comprising:
carrying out data exchange in the infrastructure network,
receiving navigation satellite system signals from the navigation satellites of the global navigation satellite system in the infrastructure network nodes, and
controlling operation of the infrastructure network nodes based on the received navigation satellite system signals,
the method further comprises:
determine atmospheric delays of the navigation satellite system signals between the navigation satellites and the infrastructure network nodes based on the received navigation satellite system signals, and
calculating atmospheric quantities between the navigation satellites and the infrastructure network nodes based on the determined atmospheric delays of the navigation satellite system signals between the navigation satellites and the infrastructure network nodes wherein the method is carried out with a system according to the claim 29.
